(19) United States
(12) Patent Application Publication
(10) Pub. No.: US 2006/0244850 A1
(43) Pub. Date: Nov. 2, 2006

(54) Image pickup apparatus and image pickup method

(75) Inventors: Koichi Mitsuo, Ome-shi (JP); Yasuhito Ambiru, Tokorozawa-shi (JP); Yuma Kudo, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/413,196

(22) Filed: Apr. 28, 2006

(30) Foreign Application Priority Data
Apr. 28, 2005 (JP) 2005-133400

(51) Int. Cl. H04N 5/20

(52) U.S. Cl. 348/255

(57) ABSTRACT

According to one embodiment, an image pickup apparatus has an image pickup unit which picks up a picture as an image and outputs a picture signal, an amplifier unit which amplifies the picture signal at an amplification rate L according to a magnitude of the picture signal from the image pickup unit and outputs the amplified picture signal, and a motion detector unit which decides a threshold value Th for motion detection in accordance with a magnitude of the amplification rate, detects a change in the amplified picture signal from the amplifier unit, and in the case where the change quantity exceeds the threshold value, determining that a motion has occurred, and outputs a motion detection signal V.

### CROSS-REFERENCE TO RELATED APPLICATION

This application is based upon and claims the benefit of priority from Japanese Patent Application No. 2005-133400, filed Apr. 28, 2005, the entire contents of which are incorporated herein by reference.

### BACKGROUND

1. Field

One embodiment of the present invention relates to an image pickup apparatus such as a network camera, and in particular, to an image pickup apparatus and an image pickup method with an automatic gain control (AGC) for a picture signal and a motion detector unit (motion detector).

2. Description of the Related Art

Recently, with prevalence of digital devices, many device types of image information devices such as digital cameras have been developed and manufactured, and use of a solid image pickup device such as a charge coupled device (CCD) camera has been generalized. In such a case, as an additional function, there is used, for example, an automatic gain control (AGC) circuit for increasing and decreasing a gain of a picture signal, a motion detector circuit for monitoring movement in a pickup image screen, or a noise reducer circuit for reducing noise in a picture signal.

Patent Document 1 (Japanese Patent No. 3526020 (Jpn. Pat. Appln. KOKAI Publication No. 2001-160909)) discloses an apparatus for reducing noise of a picture signal, the apparatus having a motion detector circuit. The apparatus extracts a motion detection signal of a given picture signal, and efficiently reduces noise of the picture signal based on the extracted signal. In addition, there is also disclosed an example of carrying out a processing operation after a level of a picture signal has been stabilized together with the AGC circuit.

However, in the above-described prior art, an AGC circuit and a motion detector circuit operate independently in the case where motion detection has been carried out after use of the AGC circuit. That is, automatic gain control using the AGC circuit at a predetermined amplification rate, and subsequent determination as to whether or not a motion occurs in a picture signal at a predetermined threshold value (such as, for example, arbitrary user setting of low, middle, and high) in the motion detector circuit are carried out independently, respectively.

However, in the case where a whole picture signal has been amplified by increasing an AGC level (amplification rate) because of shortage of a light quantity when the AGC circuit is used in a dark place while it is turned ON, a noise component included in a signal increases together with a required image signal. In this manner, in the case where, in a motion detecting process, motion detection has been carried out for an amplification signal having the increased noise component, there is a problem that the amplified noise component is mistakenly recognized as a motion in the picture signal, and a motion detection signal is outputted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram depicting an example of a configuration of an image pickup apparatus according to an embodiment of the present invention;

FIG. 2 is an illustrative diagram illustrating an example of a method of connecting a network with the image pickup apparatus according to the embodiment;

FIG. 3 is a sectional view showing an example of a configuration of the image pickup apparatus according to the embodiment;

FIG. 4 is a graph depicting an example of an operation of a motion detecting process in the image pickup apparatus according to the embodiment;

FIG. 5 is a graph depicting an example of a failure of a motion detecting process in the image pickup apparatus according to the embodiment;

FIG. 6 is a graph depicting an example of sensitivity normalization in a motion detecting process of the image pickup apparatus according to the embodiment;

FIG. 7 is a graph depicting an example of a relationship between a threshold value Th and an AGC level L in a motion detecting process of the image pickup apparatus according to the embodiment;

FIG. 8 is a graph depicting an example of a relationship between a threshold value Th and an AGC level L in a motion detecting process of the image pickup apparatus according to the embodiment;

FIG. 9 is an illustrative view illustrating an example of a relationship between an AGC detection region and a threshold value Th in the image pickup apparatus according to the embodiment;

FIG. 10 is a flow chart showing an example of a motion detecting process in the image pickup apparatus according to the embodiment;

FIG. 11 is a flow chart showing another example of the image pickup apparatus according to the embodiment;

FIG. 12 is a flow chart showing another example of the image pickup apparatus according to the embodiment; and

FIG. 13 is a flow chart showing another example of the image pickup apparatus according to the embodiment.

### DETAILED DESCRIPTION

Various embodiments according to the invention will be described hereinafter with reference to the accompanying drawings. In general, according to one embodiment of the invention, there is provided an image pickup apparatus and an image pickup method capable of precisely carrying out a motion detecting process at a later stage without being affected by an operating state of an incorporated auto gain control. An image pickup apparatus is characterized by comprising: an image pickup unit which picks up a picture and outputs a picture signal; an amplifier unit which amplifies the picture signal at an amplification rate according to a magnitude of the picture signal from the image pickup unit and outputting the amplified picture signal; and a detector unit which decides a threshold value for motion detection in accordance with the magnitude of the amplification rate, detects a change in the amplified picture signal from the amplifier unit, and in the case where the change quantity exceeds the threshold value, determines that a motion has occurred and outputs a motion detection signal.

According to the present invention, an increase or decrease of noise in the AGC circuit amplified by the motion detector unit is not mistakenly recognized as a motion or the like of a person in a picture signal.

Hereinafter, an image pickup apparatus according to an embodiment of the present invention will be described in detail with reference to the accompanying drawings.

<Example of Image Pickup Apparatus According to an Embodiment of the Present Invention>

(Configuration)

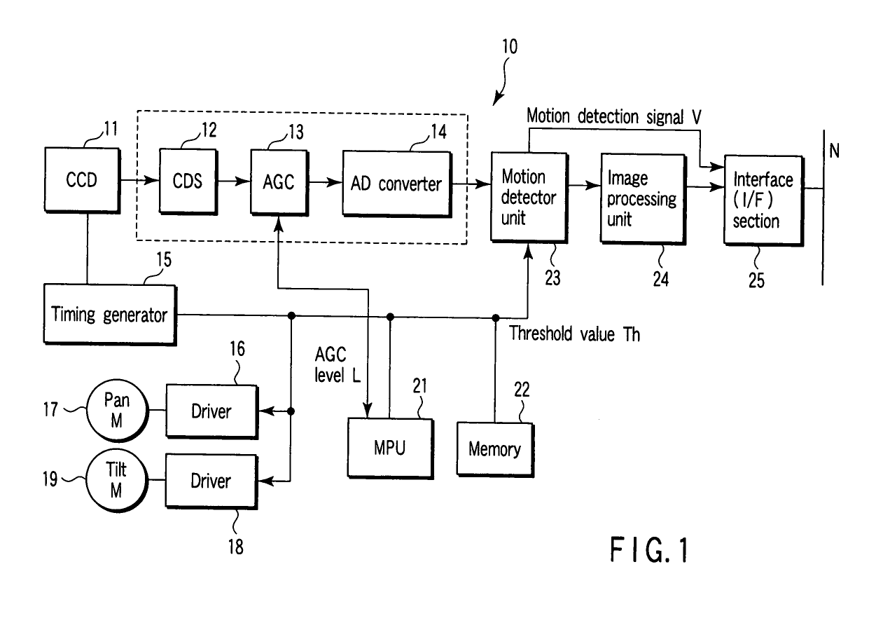

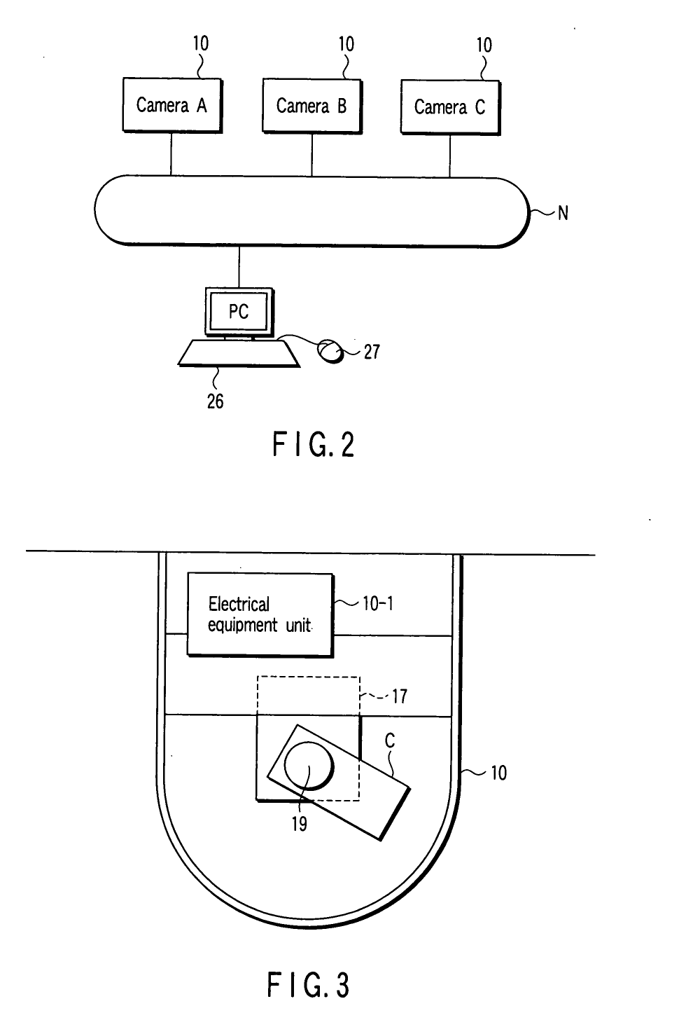

An example of an image pickup apparatus according to an embodiment of the present invention will be described here with reference to the accompanying drawings. FIG. 1 is a block diagram depicting an example of a configuration of the image pickup apparatus according to the embodiment of the invention. FIG. 2 is an illustrative view illustrating an example of a method of connecting a network with the image pickup apparatus according to the embodiment. FIG. 3 is a sectional view showing an example of a configuration of the image pickup apparatus according to the embodiment.

An image pickup apparatus 10 which is an image pickup apparatus according to the invention, as shown in FIG. 1, has a solid image pickup device (CCD; Charge Coupled Device) 11, a co-rated double sampling (CDS) circuit 12, an auto gain control (AGC) circuit 13, an AD converter 14, and a timing generator 15. The solid image pickup device 11 receives incident light having passed through an objective lens (not shown) and outputs a detection signal in accordance therewith. The CDS circuit 12 receives the output. The AGC circuit 13 makes gain control of the output. The AD converter 14 makes gain control of the output. The timing generator 15 gives an operational timing of the solid image pickup device (CCD; Charge Coupled Device) 11 or the like.

Further, the image pickup apparatus 10 has a main processing unit (MPU) 21 and a memory 22. The MPU 21 controls a whole processing operation and sets a threshold value of a motion detector unit described later. The memory 22 stores a program responsible for these operations, provides a work area for making processing operations for an image signal, or stores coordinate information included in a protection area or screen data for alarm display to be displayed during motion detection or the like.

Furthermore, the image pickup apparatus 10 has a communication unit 25 connected to the MPU 21 via a data bus. The communication unit 25 may have a local area network (LAN) communication function and a router function in addition to the Ethernet (registered trademark). The communication unit 25 makes a process for communication with, for example, an external PC 26 via a wired network or a wireless network N, and further enables connection to the Internet or the like via a DSL modem (not shown) or the like.

Still furthermore, the image pickup apparatus 10 has: a pan driver 16 controlled to be connected to the MPU 21 via a data bus for the purpose of driving a camera unit C in a pan direction; a pan driver 17 such as a stepping motor; a tilt driver 18 for further driving the camera unit C in a tilt direction; and a tilt motor 19 such as a stepping motor. Here, the camera unit C shown in FIG. 3 has at least the above-described solid image pickup device 11. In this manner, FIG. 3 explains a relationship among the camera unit C, the pan motor 17 for driving the camera unit C in the pan direction, the tilt motor 19 for driving the camera unit C in the tilt direction, and an electrical equipment unit 10-1 having a configuration shown in FIG. 1.

Further, a plurality of image pickup apparatuses 10 can be provided via the network N as shown in FIG. 2. In addition, a process for driving the image pickup apparatus 10 in the pan direction and in the tilt direction can be carried out by the PC 26 or the like via the network B, and further, the image signal picked up as an image by the image pickup apparatus 10 can be monitored or can be recorded and reproduced. The PC 26 enables easy setting of a protection area to be described later, in particular, when a pointing device such as a mouse 29 is connected to the PC.

In addition, an image processing unit 24 applies for example, image processings such as a sharpness processing, a contrast processing, a gamma correcting, a white balance processing, and a pixel addition processing to an inputted image signal.

(Basic Operation)

The image pickup apparatus 10 having such a configuration carries out a basic operation as described below. That is, the image pickup apparatus 10 can make an image pickup operation for receiving incident light from an object and supplying an image signal according its image pickup screen via a network or the like; a camera driving operation for driving the direction of the camera unit C in the pan direction or in the tilt direction, for example; mode operations based on the picked-up image signal (for example, motion detecting operation); a variety of setting operations; and a self-test operation.

More specifically, in the image pickup operation, a command signal is received from the PC 26 or the like that is a control device via the network N (or wireless network) or a wide area network (such as the Internet). The image pickup operation is made under the control of the MPU 21 in accordance with the operating program stored in the memory 22. The solid image pickup device 11 having received incident light from an object supplies a picture signal to the CDS circuit 12. With respect to a picture signal outputted from the circuit, an amplification rate L according to the magnitude of the picture signal is decided by the AGC circuit 13. Here, a threshold value Th of a motion detector unit 23 according to the decided amplification rate L is determined in the control unit 21.

The picture signal amplified by the amplification rate L at the AGC control unit 13 is A/D converted into a digital signal by the AD converter 14, and then, the converted signal is supplied to the motion detector unit 23.

The motion detector unit 23 detects the content of the picture signal amplified by the amplification rate L, for example, on a frame by frame basis. In addition, in response to a result of comparison between the previously decided threshold value Th and a picture signal, for example, if a change quantity of a picture signal exceeds the threshold value Th, it is determined that a motion of a picture of a person or the like has occurred in a picture region, and a motion detection signal V or the like is outputted via an interface (I/F) unit 25 or the like. Similarly, a picture signal is externally outputted via the I/F unit 25 after image processings such as a sharpness processing, a contrast processing, a gamma correction, a white balance processing, a pixel addition processing, and a JPEG compression or MPEG compression are applied to the picture signal in the image processing unit 24 or the like.

In addition, in the camera driving operation, the MPU 21 always recognize the direction of the current camera unit C after zero coordinate adjustment has been made in the pan motor 17 and the tilt motor 19 which are stepping motors. In this manner, the MPU 21 always manages a coordinate of a screen on which the current camera unit C picks up an image. An image pickup screen is changed by driving the camera unit C in the pan direction or in the tilt direction in response to an operation control signal supplied from the MPU 21 to a driver, and at the same time, the MPU 21 always recognizes the coordinate of the current image pickup screen. Therefore, a user can move the camera unit C in the pan direction or in the tilt direction while watching an image pickup screen in response to the image signal supplied from the current image pickup apparatus 10 from a screen of the PC 26 or the like connected via the network, and can watch the image pickup screen according to the movement.

If, in the above-described motion detector unit, an observation region of motion detection in the image pickup screen is set in response to the user's operation, and then, a change of a threshold value or more on the pickup screen is detected in the observation region in the set period, the MPU 21 determines that motion detection occurs. Then, the MPU 21 outputs a motion detection signal V and makes an operation of outputting an alarm signal or outputting an alarm screen stored in the memory 22 to be added in an image signal.

<Motion Detector Unit Having Threshold Value Th in Response to AGC Level L According to an Embodiment of the Present Invention>

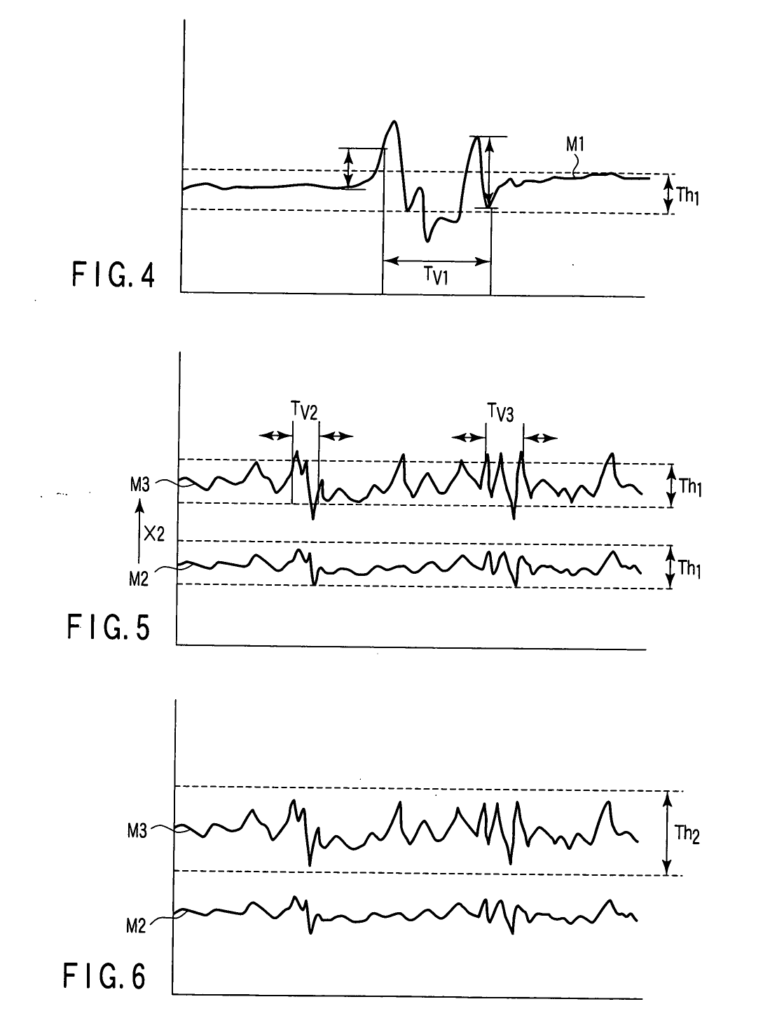

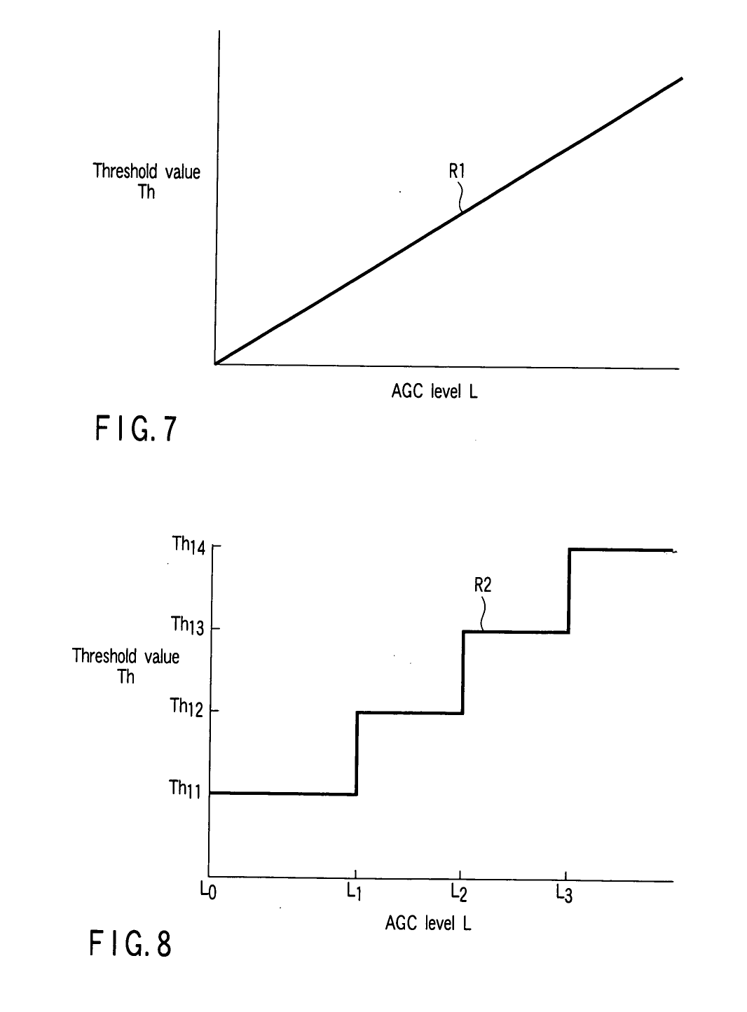

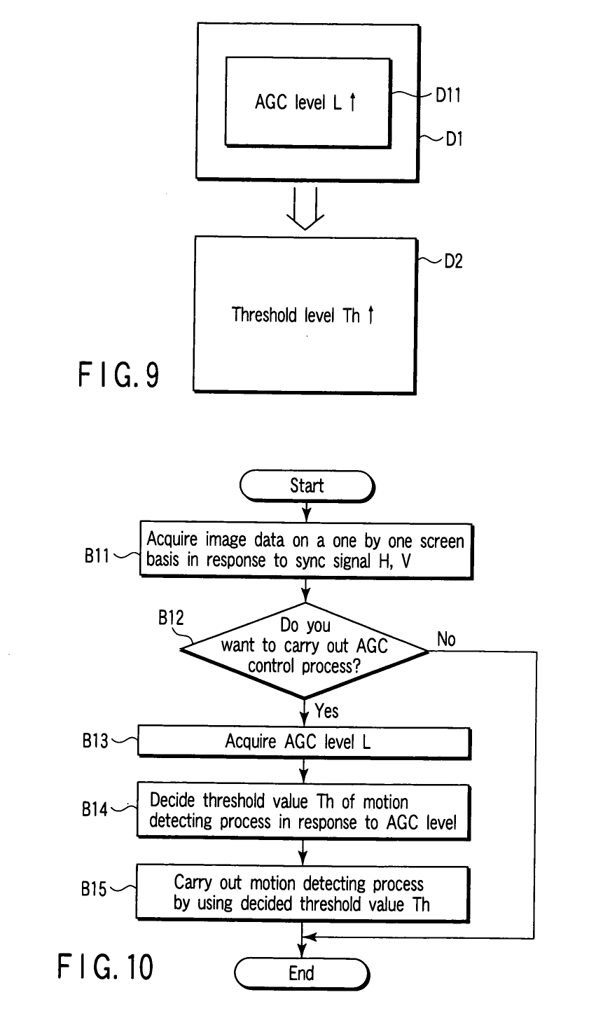

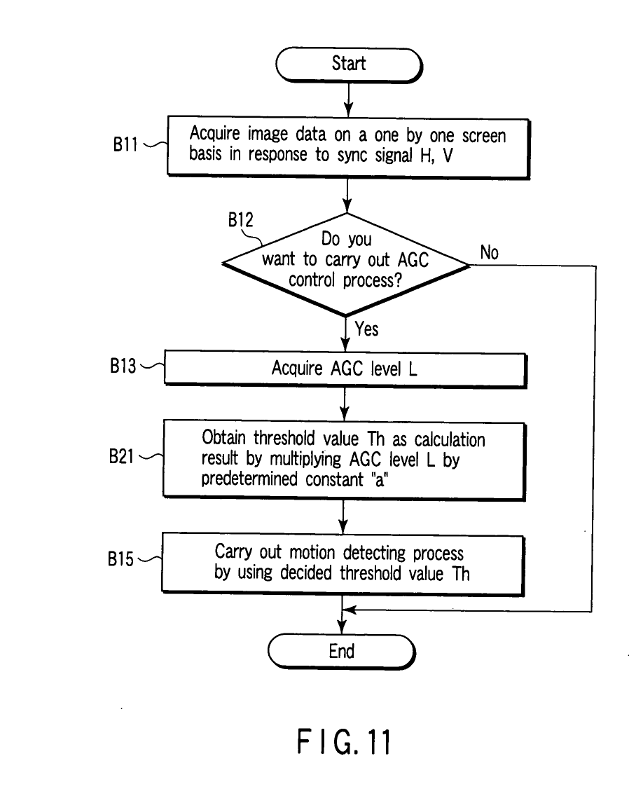

Now, with reference to a flow chart, a detailed description will be given to a relationship between the AGC level L of the AGC circuit according to the embodiment of the invention and the threshold value Th of the motion detector unit 23. FIG. 4 is a graph depicting an example of an operation of a motion detecting process in the image pickup apparatus according to the embodiment. FIG. 5 is a graph depicting an example of a failure of a motion detecting process in the image pickup apparatus according to the embodiment. FIG. 6 is a graph depicting an example of sensitivity normalization in a motion detecting process of the image pickup apparatus according to the embodiment. FIG. 7 is a graph depicting an example of a relationship between a threshold value Th and an AGC level L in a motion detecting process of the image pickup apparatus according to the embodiment. FIG. 8 is a graph depicting an example of a relationship between a threshold value Th and an AGC level L in a motion detecting process of the image pickup apparatus according to the embodiment. FIG. 9 is an illustrative view illustrating an example of a relationship between an AGC detection region and a threshold value Th in the image pickup apparatus according to the embodiment. FIGS. 10 to 13 are flow charts each showing an example of a motion detecting process in the image pickup apparatus according to the embodiment.

(Failure of Mistaken Recognition of Motion Detector Unit)

First, a failure in normal operation of the motion detector unit 23 will be described in detail with reference to FIGS. 4 and 5. A picture signal M1 supplied from the A/D converter 14 is continuously monitored by the motion detector unit 23, and a motion in a picture is detected through a process for comparison with a predetermined threshold value Th1. At this time, if a motion of a person or the like occurs in a picture at a first timing Tᵥ₁ shown in FIG. 4, such a motion appears as a change in the picture signal. Here, in the case where a change in value of the picture signal is greater than the threshold value Th1, the motion detector unit 23 outputs a motion detection signal V if it determined that a motion occurs. Alternatively, depending on the determination of the MPU 21, a warning image or the like stored in the memory 22 is read out and externally outputted, or is notified via the network N to the networked PC or the like.

However, in the case where a whole screen is lightly dark in a picture signal, trajectory such as a picture signal M2 in the graph shown in FIG. 5 is obtained. Here, the picture signal M2 is produced as a picture in the case where a screen is still and does not change, for example, in the case where the room at night is continuously picked up as an image by a monitor camera. At this time, it should be noted that noise caused by a value equal to or smaller than the predetermined threshold value Th1 of the motion detector unit 23 is included in the screen. In the case where the AGC circuit does not operate, the motion detector unit 23 does not mistakenly recognize this change in noise as a motion in the screen.

In an actual apparatus, however, the ACG circuit 13 always monitors the picture signal M2, determines that the picture signal should be amplified if a magnitude of the picture signal is equal to or smaller than a predetermined value, and amplifies and outputs the picture signal in accordance with an AGC level L which is a desired amplification value. At this time, a value of the picture signal itself is amplified to, for example, about 2 times as large as usual, and a noise component loaded on the picture signal is also amplified, as shown in a picture signal M3 of FIG. 5.

As a result, in the picture signal M2 before amplified, the noise component which has been equal to or smaller than the threshold value Th1 exceeds the threshold value Th1 at a second timing Tᵥ₂ shown in the figure in the picture signal M3 after amplified.

Therefore, the motion detector unit 23 mistakenly determines that a motion has occurred in the picture signal. Thus, there occurs a failure that the motion detection signal V is mistakenly supplied based on the fact that the motion detector unit mistakenly recognizes that a motion has been detected with respect to a picture such as a still image in which nobody should be there at night.

(Decision of Threshold Value Th in Response to AGC Level L According to an Embodiment of the Present Invention)

In contrast, a picture pickup apparatus according to an embodiment of the present invention is intended to solve the failure by setting a threshold value Th of the motion detector unit 23 in response to an AGC level L of the AGC circuit 13. Namely, in the case where a picture signal has been amplified by the AGC circuit 13, the threshold value Th of the motion detector unit 23 is also amplified concurrently, avoiding mistaken recognition.

More specifically, the picture pickup apparatus according to the embodiment of the invention sequentially acquires picture signals from the CCD 11 on a one by one screen basis in response to a horizontal sync signal H and a vertical sync signal V first supplied from the timing generator 15 in the flow chart of FIG. 10 (block B11). Then, the MPU 21 which is a control unit checks a mode for making automatic gain control of the AGC circuit 13 (block B12), and then, acquires a value of an AGC level L decided by the AGC circuit 13 (block B13). Subsequently, the MPU decides a threshold value Th of a motion detecting process depending on the AGC level (block B14). A specific method of the decision can be provided in a variety of modes as described later.

Thereafter, in response to the decided threshold value Th2, whether or not a motion exists with respect to an output of the A/D converter 14 is detected by comparing a picture signal and a threshold value with each other in a real time, as shown in, for example, FIG. 6 (block B15). In FIG. 6, it is evident that no malfunction occurs because a noise component of the amplified picture signal M3 is equal to or smaller than a new threshold value Th2.

In the case where a motion has been detected, for example, the motion detection signal V is outputted to the I/F section 25 in accordance with an instruction from the control unit 21 or determination of the motion detector unit 23, or alternatively, in accordance with a command from the control unit 21, image information on a warning screen stored in the memory 22 can be outputted to the I/F section 25 or the like.

Consequently, even if the AGC circuit 13 amplifies a picture signal thereby increasing a noise component, the threshold value Th of the motion detector unit 23 is also set to a proper value concurrently. This makes it possible to carry out reliable motion detection and AGC processing at the same time without causing mistaken recognition.

As has been described above, according to the present invention, when the picture signal is amplified at a desired AGC level (amplification rate L) by an AGC circuit (amplifier unit) in the case where a picture signal is wholly dark or the like, a threshold value for use in motion detection is decided depending on a value of the amplification rate L in a motion detector unit at a later stage as well. As an example, in the case where a gain is doubled by the AGC circuit, the motion detector unit at the later stage also carries out a processing for doubling a threshold value of motion detection. In this manner, an increase or decrease in noise of the AGC circuit amplified by the motion detector unit is not mistakenly recognized as a motion or the like of a person in a picture signal.

Therefore, there is provided an image pickup apparatus and an image pickup method capable of carrying out a reliable motion detecting process without causing mistaken recognition of the motion detecting process even on a slightly dark screen.

(Operation in Case of Linear Threshold Value Th)

Furthermore, with reference to a flow chart shown in FIG. 11, a description will be given to a case of providing a comparatively linear threshold value Th. That is, in this case, an AGC level L and a threshold value Th are decided as a substantially linear relationship, as indicated by trajectory R1 of FIG. 7 (block B21).

Namely, if the AGC level L which is an amplification rate is about 1.5 times as high as usual, the threshold value Th is also 1.5 times as high as usual concurrently. In addition, if the AGC level L is about 2 times as high as usual, the threshold value Th is also 2 times as high as usual concurrently. When both of the actually measured data are close to such a value, a computing process can be carried out more easily by obtaining a relationship between the two numerical values as linear values, and reliable operation can be made.

(Operation in Case of Stepwise Threshold Value Th)

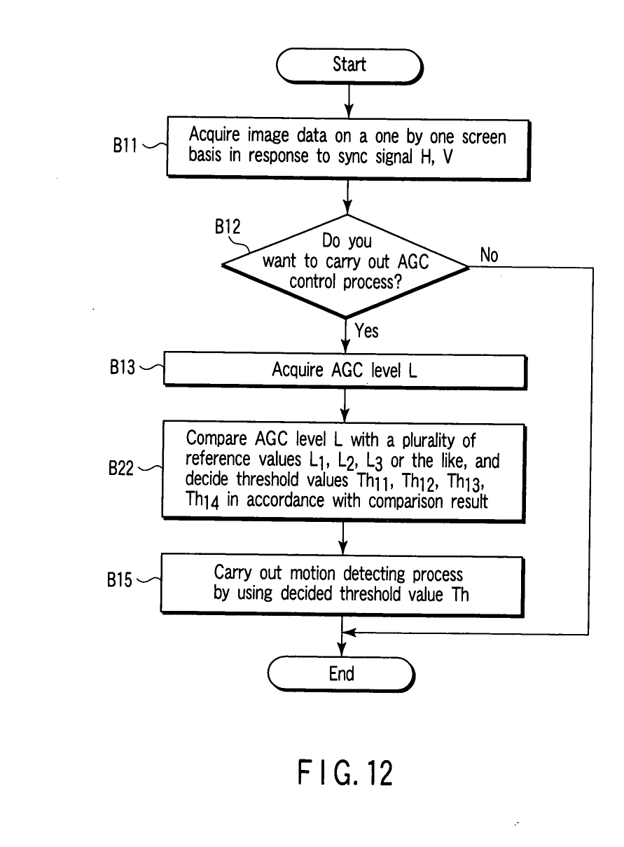

Still furthermore, a description will be given to a case of providing a stepwise threshold value Th with respect to the flow chart shown in FIG. 12. That is, in this case, as indicated by trajectory R2 in a graph of FIG. 8, an AGC level is first compared with a plurality of predetermined reference values L₁, L₂, L₃, and a first threshold value Th₁₁, a second threshold value Th₁₂, a third threshold value Th₁₃, and a fourth threshold value Th₁₄ are applied, respectively, in accordance with a relationship obtained by the comparison (block B22). In this case as well, a desired threshold value can be obtained in accordance with a comparatively simple computing process.

(Operation in Case of Threshold Value Th Based on Matrix Data)

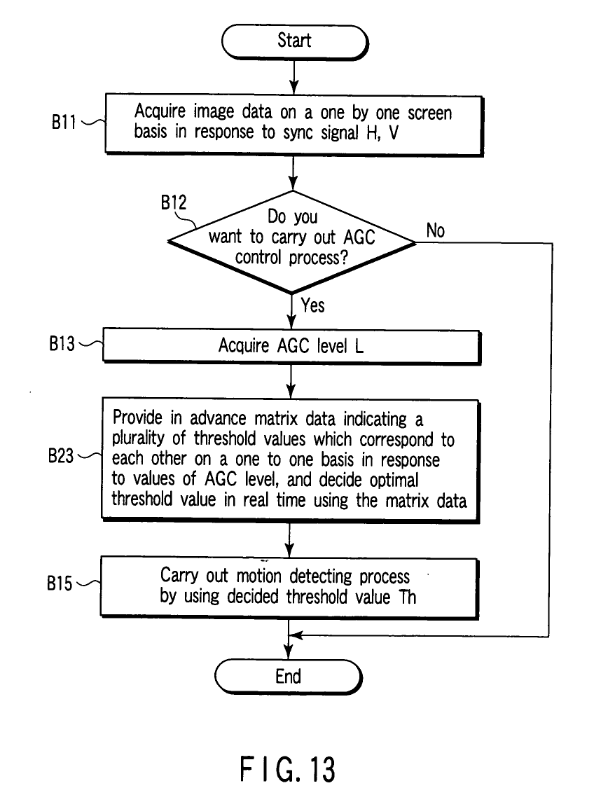

Yet furthermore, in the flow chart shown in FIG. 13, ideal matrix data is prepared in advance in the memory 22 or the like, corresponding threshold values Th are read out in series in accordance with an AGC level, and the threshold values are decided. More specifically, assume that, for example, an AGC level L is expressed in 256 stages and a threshold value is expressed in 256 stages. In such a case, on the presumption of one to one correlation matrix data such as (AGC level L, threshold value Th)=(0, 0), (1, 1), (2, 1), (3, 2), . . . , (150, 125), (151, 127), . . . , (256, 256), such matrix data are stored in, for example, the memory 22. Then, required data is read out from the memory 22, and is referred to every time, and a threshold value Th is decided. Since an optimal threshold value Th can be provided by using such a method, it is possible to carry out motion detection based on the most proper threshold value although a processing time becomes a burden.

Moreover, FIG. 9 shows a case in which, when the AGC circuit 13 decides an AGC level L, a reference picture signal is produced in a central predetermined region D11 instead of producing a picture signal on one screen face D1. Consequently, in the case where an object of interest is set at the center of a screen, an AGC level L can be decided while focusing on brightness of the object in particular. Thereafter, in a screen D2, a fully uniform, proper threshold value Th is decided and assigned in accordance with the AGC level L.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image pickup apparatus, comprising:
an image pickup unit which picks up a picture as an image and outputs a picture signal;
an amplifier unit which amplifies the picture signal at an amplification rate according to a magnitude of the picture signal from the image pickup unit and outputs the amplified picture signal; and
a motion detector unit which decides a threshold value for motion detection in accordance with a magnitude of the amplification rate, detects a change in the amplified picture signal from the amplifier unit, and in the case where the change quantity exceeds the threshold value, determines that a motion has occurred and outputs a motion detection signal.

2. An image pickup apparatus according to claim 1, wherein the magnitude of the amplification rate of the motion detector unit is proportional to a threshold value.

3. An image pickup apparatus according to claim 1, wherein plural types of threshold values are used in response to the magnitude of the amplification rate of the motion detector unit.

4. An image pickup apparatus according to claim 1, wherein a plurality of threshold values provided in advance in a storage region are used, the threshold values corresponding to the magnitude of the amplification rate of the motion detector unit on a one to one basis.

5. An image pickup apparatus according to claim 1, wherein the amplification rate is decided depending on a magnitude of a picture signal according to a predetermined region in one screen per picture signal from the image pickup unit.

6. An image pickup method comprising:
picking up a picture as an image and outputting a picture signal;
amplifying the picture signal at an amplification rate according to a magnitude of the picture signal and outputting the amplified picture signal; and
deciding a threshold value for motion detection in accordance with a magnitude of the amplification rate, detecting a change in the amplified picture signal, and in the case where the change quantity exceeds the threshold value, determining that a motion has occurred and outputting a motion detection signal.

7. An image pickup method according to claim 6, wherein the magnitude of the amplification rate is proportional to a threshold value.

8. An image pickup method according to claim 6, wherein plural types of threshold values are used in response to the magnitude of the amplification rate.

9. An image pickup method according to claim 6, wherein a plurality of threshold values provided in advance in a storage region are used, the threshold values corresponding to the magnitude of the amplification rate on a one to one basis.

10. An image pickup method according to claim 6, wherein the amplification rate is decided depending on a magnitude of a picture signal according to a predetermined region in one screen with respect to the picture signal.
